(19) United States
(12) Patent Application Publication
(10) Pub. No.: US 2026/0086892 A1
(43) Pub. Date: Mar. 26, 2026

(54) AUTOMATIC RUN-TIME SKEW-AWARE OPTIMIZATION OF ROOTED COLLECTIVES

(71) Applicant: XILINX, INC., San Jose, CA (US)

(72) Inventors: Lucian PETRICA, Dublin (IE); Tobias ALONSO PUGLIESE, Dublin (IE)

(21) Appl. No.: 18/895,308

(22) Filed: Sep. 24, 2024

(51) Int. Cl. G06F 9/54

(52) U.S. Cl. CPC G06F 9/547; G06F 9/546; G06F 2209/544; G06F 2209/548

(57) ABSTRACT

Automatic run-time skew-aware optimization of rooted collectives includes determining skews amongst compute nodes of a distributed computing system, as an application executes on the compute nodes, and determining implementations for collective operations of the application based at least in part on the skews. Skews may be determined based on timestamps of operations of the application program. Time stamps of one or more of the compute nodes may be estimated or inferred from timestamps of other compute nodes. Timestamps may be aggregated to determine global skews. Collective implementations may be determined for a sequence of collective operations based on skew impacts amongst the sequence of collective operations. Subsequent collective operations may be predicted based on current collective operations and a history of persistent collective operations, and implementations may be determined for the predicted collective operations prior to receipt of calls for the predicted collective operations.

### BACKGROUND

An application program may execute on a distributed computing system (e.g., a network of compute nodes) as a distributed bulk-synchronous workload, where compute nodes of the distributed computing platform alternate between execution of application instructions and communicating data and/or instructions to/amongst co-executing compute nodes. The communications may be based on a finite set of global patterns, referred to as collectives or collective operations. A collective operation defines a relationship between a starting location of data and a location of the data at the conclusion of the collective operation.

Examples collective operations are provided below. Collective operations are not, however, limited to the following examples. A broadcast collective provides a message (e.g., data and/or instructions) from one compute node (root) to multiple other compute nodes. A scatter collective apportions a message amongst multiple compute nodes. A scatter collective differs from a broadcast collective in that a scatter collective does not send the same message to the multiple compute nodes processing units. Rather, a scatter collective divides the message into subsets and delivers the subsets to respective compute nodes. A gather collective gathers and stores data from multiple compute nodes on a selected compute node. A reduce collective collects and combines results or partial results from the compute nodes to provide a global result. A barrier collective causes or allows a compute node that reaches a defined execution point to wait for other compute nodes to reach respective defined execution points. A barrier collective operation may be used to synchronize multiple compute nodes.

A collective operation may be implemented through several point-to-point send/receive operations in a specific sequence, which may be referred to as an implementation of the collective. As an example, where a root compute node is to broadcast a message (e.g., data and/or instructions) to multiple other compute nodes, the root compute node may broadcast directly to the other compute nodes as the respective compute nodes become available, referred to as a first-come first-served (FCFS) basis. This may be suitable for some situations, but may result in wait periods in which one or more compute nodes are idled. Alternatively, the root compute node may broadcast to one or more compute nodes indirectly via one or more other compute nodes. Such an approach may be suitable for some situations, but may also result in wait periods in which one or more compute nodes are idle. Collective operations may relate to critical paths of an application program in which idle compute nodes may be undesirable. Collectives may be useful in single-program multiple data (SPMD) applications and/or other application.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts a distributed processing system for executing an application program, according to an embodiment.

FIG. 2A depicts a matrix multiplication.

FIG. 2B depicts a distributed column-parallel matrix multiplication, according to an embodiment.

FIG. 2C depicts a distributed row-parallel matrix multiplication, according to an embodiment.

FIG. 3 depicts a collective manager, according to an embodiment.

FIG. 4 depicts a collective manager, according to another embodiment.

FIG. 5 is flowchart of a method of selecting implementations for collective operations of an application program, according to an embodiment.

FIG. 6A depicts a skew-unaware pipelined (i.e., segmented) linear reduction operation.

FIG. 6B depicts ordering of the reduction operation of FIG. 6A.

FIG. 7A depicts a skew-aware reduction operation, according to an embodiment.

FIG. 7B depicts ordering of the reduction operation of FIG. 7A.

FIG. 8A depicts a skew-unaware pipelined linear broadcast.

FIG. 8B depicts ordering of the broadcast of FIG. 8A.

FIG. 9A depicts a skew-unaware first-come first-serve (FCFS) tree broadcast.

FIG. 9B depicts ordering of the broadcast of FIG. 9A.

FIG. 10A depicts a skew-aware pipeline broadcast, according to an embodiment.

FIG. 10B depicts ordering of the broadcast of FIG. 10A, according to an embodiment.

FIG. 11A depicts a skew-unaware FCFS scatter operation.

FIG. 11B depicts ordering of the scatter operations of FIG. 11A.

FIG. 12A depicts a skew-aware scatter operation, according to an embodiment.

FIG. 12B depicts ordering of the scatter operations of FIG. 12A, according to an embodiment.

FIG. 13A depicts a skew-unaware FCFS gather operation.

FIG. 13B depicts ordering of the gather operations of FIG. 13A.

FIG. 14A depicts a skew-aware gather operation, according to an embodiment.

FIG. 14B depicts ordering of the gather operations of FIG. 14A, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe automatic run-time skew-aware optimization of rooted collectives.

Bulk-synchronous workloads in a distributed platforms (e.g. a cluster/pod of GPUs) alternate between compute and synchronizing collective communication (broadcast, scatter, gather, reductions etc.). Asymmetries in collective operation, and possible differences in computations executed by compute nodes, result in skew (i.e., misalignment, or differing degrees of progress) amongst the compute nodes, resulting in idle times as compute nodes which arrive early at the next collective operation must wait for other compute nodes to catch up, reducing performance. As an example, compute nodes may complete a preceding collective operation at different times and may thus become available for a subsequent collective at different times. As another example, compute nodes may require differing lengths of time to execute respective computations, and may thus provide computation results at differing times. Failure to account for run-time behaviors of the application program when selecting an implementation for a collective operation may result in idle compute nodes and/or may exacerbate skews amongst the compute nodes.

An implementation of a collective may be selected in isolation (i.e., based on static assumptions), without consideration of characteristics of compute aspects of an executing application program, such as relative skew amongst compute nodes. As an example, an implementation of a collective operation may be selected based on static assumptions that all compute nodes are available for a collective operation at the same time and/or that all compute node will execute computations at the same time. However, a collective implementation that is optimal for a synchronized start, may be sub-optimal if compute nodes are skewed at the start. Conversely, in some situations, pre-start skews may shorten the apparent duration of a collective below the theoretical minimum.

Pre-start skews may be accommodated with out-of-order transfers in the case of tree-based implementations of collectives (i.e., first-come first-serve), where each point-to-point communication starts as soon as both ends are ready, rather than the order of transfers being pre-determined. First-come first-serve (FCFS) methods may exhibit better skew absorption than other methods that assume aligned compute nodes.

Other approaches are also possible. Absent knowledge of run-time skews, however, it may not be possible to determine whether a FCFS tree-based implementation for a given collective operation will be faster than another implementation (e.g. a ring-based method) of the collective operation. Generally, FCFS is only guaranteed optimal if skews are larger than the transmit time for one message. Therefore, choosing a FCFS tree to cater to a worst-case scenario (i.e., large skews) may hurt performance in a best-case scenario (i.e., no skews). In addition, FCFS is only applicable within a fan-in tree of a specific compute node (i.e. a compute node can only change the order of transfers that are assigned to it). If the tree is hierarchical rather than flat, then some pre-determined assignment may be performed between P compute nodes to generate a N-ary tree where fan-in is N. For smaller values of N, FCFS becomes less effective.

Another approach is static and dynamic collective optimization method. For static optimization, thresholds are optimized based on benchmarks. For dynamic optimization, start-acknowledge (SACK) messages are used for the root compute node, and compute node ordering of a previously selected method topology is re-ordered. Since the method and compute node re-ordering are a joint optimization problem, a greedy approach is not guaranteed to yield good results (e.g., the static optimization may choose incorrect method thresholds simply because the assumed order was incorrect relative to real execution). Additionally, an inability to adapt the method (e.g., tree vs ring), at run-time is a disadvantage.

Another approach for orthogonal optimization for bulk-synchronous collectives is persistent collective operations, in which implementations are prepared ahead-of-time to avoid housekeeping-related delays (e.g. allocating buffers) at collective call-time. This concept is useful if collectives are called repeatedly (e.g., from inside a loop to reduce the duration of collectives), but may suffer from skews-related issues described further above.

An alternative to bulk-synchronicity is fine-grained interleaved computation and communication, such as the Partitioned Global Address Space (PGAS) programming model. In these frameworks, computational kernels issue fine-grained communication requests (e.g., puts implemented as RDMA writes) to implement data movement, which allows better compute/communication overlap compared to bulk-synchronous approaches, potentially adapting better to skews at run-time. However, these approaches requires visibility into the entire application and therefore cannot be readily applied to legacy codes without extensive rewrites. Furthermore, collective communication library (CCL) performance portability of PGAS codes is challenging because modern CCLs have many kernels optimized for different input sizes and computing system architectures, and many collective implementations optimized for different topologies. Creating fast fused PGAS kernels for every combination of compute and collective can be complex and expensive. Such approaches may also be limited to a subset of applications for which the communication can be moved off a critical path. This excludes many artificial intelligence based inferencing workloads, such as tensor-parallel large language models (LLMs).

Automatic run-time skew-aware optimization of rooted collectives, as disclosed herein, determines implementations for collective operations (e.g. root compute node selection, communication sequence, sub-domain partitioning, and/or other parameters) to reduce/absorb misalignments created upstream based on run-time determinations of the misalignments (i.e., measured and/or predicted) amongst compute nodes.

In an example, a collective manager receives a call for a collective operation from an application program, and determines (e.g., select and/or constructs) an implementation of the collective operation based at least in part on run-time information of the application program. The run-time information may include timestamps from compute nodes and/or the application program. The timestamps may relate to relevant operations of the compute nodes and/or the application program such as, without limitation, start times, end times, and/or durations of prior and/or current collective implementations of the application programs and/or compute operations of the compute nodes. The collective manager may derive information based on the timestamps, and may construct/select an implementation for a collective based on the derived information. The collective manager may, for example, determine and/or predict current/actual skews amongst the compute nodes based on the timestamps. The collective manager may also accumulate the timestamps and/or predict timestamps, and may determine (e.g., compute and/or predict) global skews based on the accumulated and/or predicted timestamps. The collective manager may also detect skew patterns resulting from previous collective operations, and/or may detect spurious skew patterns resulting from operating system and/or network noise, based on the timestamps. The collective manager may determine collective implementations to absorb skew, reduce/minimize durations of communication kernels, and/or reduce/minimize total execution time.

The collective manager performs automatic run-time skew-aware optimization of rooted collectives without requiring visibility into the application program or manual tuning of communication code. The collective manager may thus be useful as a replacement for legacy CLL systems.

Automatic run-time skew-aware optimization of rooted collectives may be useful to avoid idle times in distributed applications where computation and collective communication are interleaved.

Automatic run-time skew-aware optimization of rooted collectives may be useful for machine learning (ML) workloads, including training and inference, and/or other bulk-synchronous workloads.

Automatic run-time skew-aware optimization of rooted collectives may provide increased performance (e.g., computation throughput and latency) of bulk-synchronous workloads, on existing and future distributed computing systems.

Automatic run-time skew-aware optimization of rooted collectives may be useful to improve CLLs.

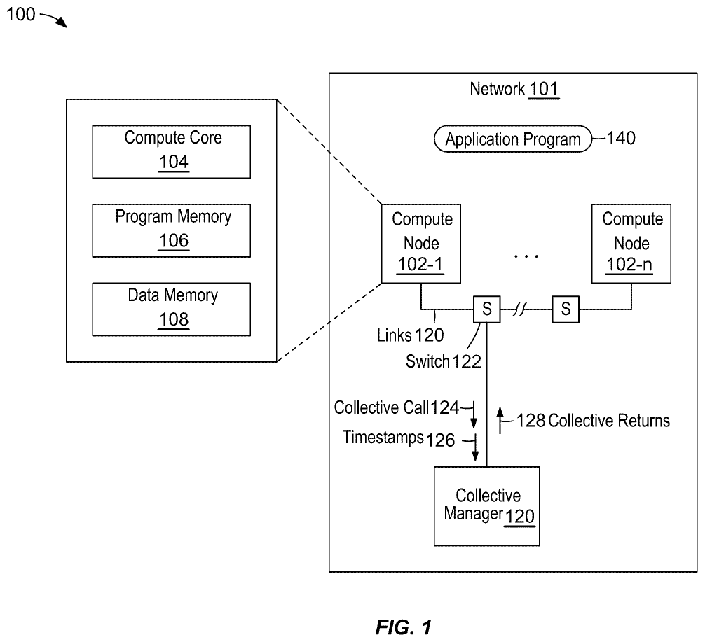

FIG. 1 depicts a distributed processing system (system) 100 for executing an application program 140, according to an embodiment. System 100 may represent a bulk synchronous parallel (BSP) computing system. System 100 is not, however, limited to BSP computing systems. Application program 140 may include, for example and without limitation, a machine learning (ML) application (e.g., training and/or inference).

System 100 includes a network 101 of compute nodes 102-1 through 102-n (collectively, compute nodes 102). Compute nodes 102 may be distributed amongst multiple geographically dispersed sites (e.g., data/server farms), co-located within a facility/building (e.g., servers within a data/server farm), and/or co-located on an integrated circuit device.

Compute nodes 102 may represent respective computer systems (e.g., servers), integrated circuit (IC) devices (e.g., IC dies, IC packages, and/or circuit cards), compute tiles or artificial intelligence engines of a field-programmable gate array (FPGA). One or more compute nodes 102 may represent a graphics processing unit (GPU) or a cluster/pod of GPUs. Compute nodes 102 may be similar or identical to one another. Alternatively, or additionally, one or more compute nodes 102 may differ from other compute nodes 102.

In the example of FIG. 1, compute node 102-1 includes a compute core 104 (i.e., one or more instruction processors), program memory 106 that stores instructions for execution by compute core 104, and data memory 108 that stores data for use by compute core 104 and/or data generated by compute core 104. Data memory 108 may be referred to as level 1 (L1) memory. Compute core 104 may have access to data memory or one or more other compute nodes 102. Compute node 102-1 may include additional circuitry, such as a direct memory access (DMA) engine. The DMA may directly access data memory 108, and may be configurable to access shared memory that is accessible to multiple compute nodes 102 (e.g., level 2 memory), and/or external memory (i.e., level 3 memory). Compute node 102-1 may further include a network interface controller (NIC).

Compute node 102-1 is not limited to the example of FIG. 1.

Network 101 may be arranged as a hierarchical distributed computing system in which one or more compute nodes 102 represents a network of compute nodes and corresponding interconnects.

System 100 further includes interconnects, illustrated here as links 120, to provide communication links/paths amongst compute nodes 102. Links 120, or a subset thereof, may represent a packet-based network, such as the Internet, a proprietary packet-based network, and/or a network-on-chip (NoC). Alternatively, or additionally, links 120, or a subset thereof, may represent serialized communication links, such as AXI-based links within an IC device, serialized and time-division multiplexed communications between multi-gigabit transceivers, and/or other type(s) communication links. The interconnects may further include routing switches 122.

Application program 140 may execute on compute nodes 102 as a distributed bulk-synchronous workload, such that compute nodes alternate between executing application program 140 and communicating messages (e.g., data and/or instructions) to/amongst co-executing compute nodes 102. Application program 140 may issue calls for collective operations to manage message distribution.

System 100 further includes a collective manager 120 that constructs/selects a collective implementation for a requested collective operation specified in a collective call 124 from application program 140, and based further on timestamps 126. Timestamps 126 may relate to events of application program 140, such as start times, completion times, and/or durations of prior and/or current collective operations and/or computations of application program 140. Compute nodes 102 may include respective timestamp circuitry that provide timestamps 126. Alternatively, or additionally, application program 140 may include code to cause compute cores of compute nodes 102 to provide timestamps 126. Alternatively, or additionally, NICs of one or more compute nodes 102 may provide timestamps 126. Alternatively, or additionally, a host system may provide timestamps 126.

Collective manager 120 may represent an application program executing on one or more compute nodes 102, a host device, a NIC, a thread executing on one of the foregoing, and/or multiple threads executing on respective ones of the foregoing or a subset thereof. In the example of FIG. 1, collective manager 120 is depicted within network 100. In another example, collective manager 120 may reside outside of network 100. Example implementations of collective manager 120 are provided further below.

In FIG. 1, system 100 further includes a collective manager 120 that manages collectives for network 101 based on metrics associated with an application executing on network 101, such as misalignment or skew between compute nodes 102. Collective manager 120 may manage collectives for network 101 based further on static properties of network 101, such as physical topology, latency, and/or bandwidth of links. Collective engine 120 may include logic and/or a processor and memory encoded with instructions for execution by the processor. Collective manager 120, or portions thereof, may be incorporated within a host device and/or within one or more compute nodes 102, examples of which are provided below.

Example collective operations are provided below for a matrix multiplication. Matrix multiplication is often used for tensor parallel training and inference, and in other applications, including scientific applications.

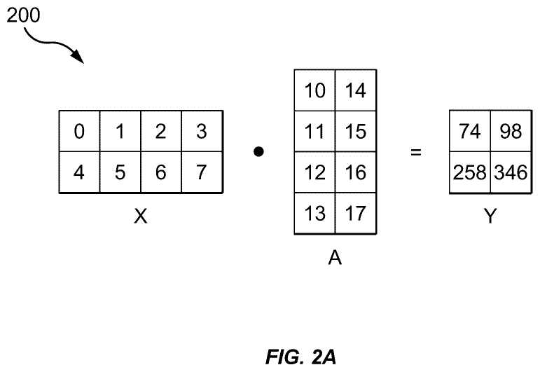

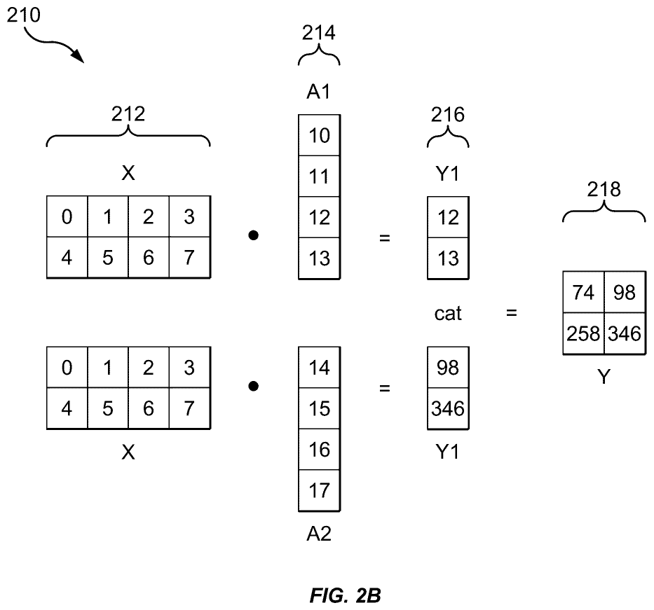

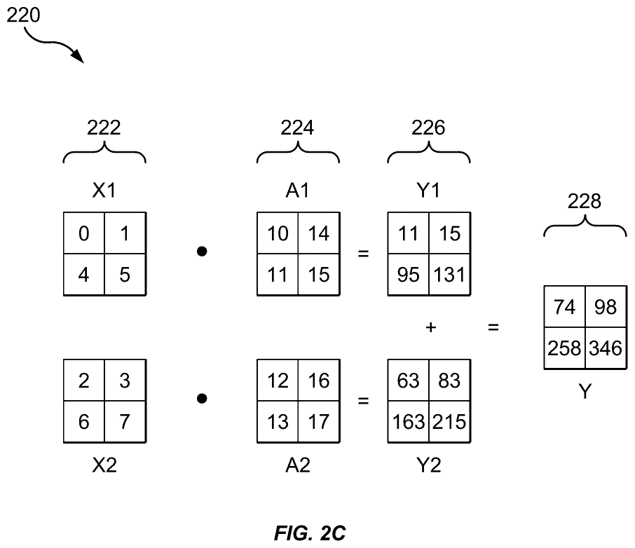

FIG. 2A depicts a matrix multiplication 200, according to an embodiment. Matrix multiplication 200 includes multiplication of matrixes X and A to provide a resultant matrix Y.

FIG. 2B depicts a distributed column-parallel matrix multiplication (matrix multiplication) 210, according to an embodiment. Matrix multiplication 210 includes a broadcast of matrix X at 212, in which matrix X is distributed to multiple compute nodes 102. Matrix multiplication 210 further includes a scatter of columns of matrix A at 214, in which columns of matrix A are provided to respective compute nodes. A first column of matrix A (i.e., A1) may be provided to compute node 102-1, and a second column of matrix A (i.e., A2) may be provided to compute node 102-n. Matrix multiplication 210 further includes parallel matrix multiplications at 216 by the respective compute nodes, to provide respective matrices Y1 and Y2, followed by a gather collective of Y1 and Y2, at 218, to provide resultant matrix Y. In machine learning (ML) workloads, columns of matrix A may be scattered in advance (i.e., pre-scattered).

FIG. 2C depicts a distributed row-parallel matrix multiplication (matrix multiplication) 220, according to an embodiment. Matrix multiplication 230 includes a broadcast of matrix X at 222, in which matrix X is distributed to multiple compute nodes102. Matrix multiplication 220 further includes a scatter of rows of matrix A at 224, in which a rows of matrix A are provided to respective compute nodes. A first set of rows of matrix A (i.e., A1) may be provided to compute node 102-1, and a second set of rows of matrix A (i.e., A2) may be provided to compute node 102-n. Matrix multiplication 220 further includes parallel matrix multiplications at 226 by the respective compute nodes, to provide respective matrices Y1 and Y2, followed by gather and reduce collectives of Y1 and Y2, at 228, to provide resultant matrix Y. In ML workloads, rows of matrix A may be scattered in advance.

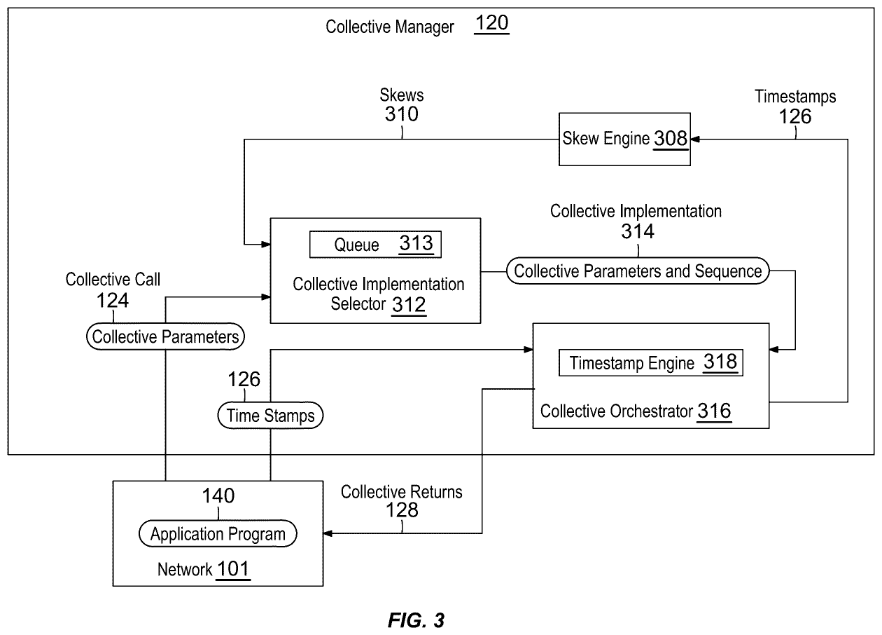

FIG. 3 depicts collective manager 120, according to an embodiment. In the example of FIG. 3, collective manager 120 includes a skew engine 308 that determines (i.e., computes and/or estimates) misalignment or skews 310 amongst compute nodes 102 based on timestamps 126. Skew engine 308 may determine skews 310 related to start times, completion times, and/or durations of collective operations and/or computations of application program 140. Skew engine 308 may determine skews 310 as relative skews amongst compute nodes 102.

Collective manager 120 further includes a collective implementation selector 312 that determines (i.e., selects and/or constructs) a collective implementation 314 for the collective operation specified in call 124 based at least in part on skews 310. Collective implementation selector 312 may include an analytic/statistical model and/or a machine learning (ML) model (e.g., a neural network).

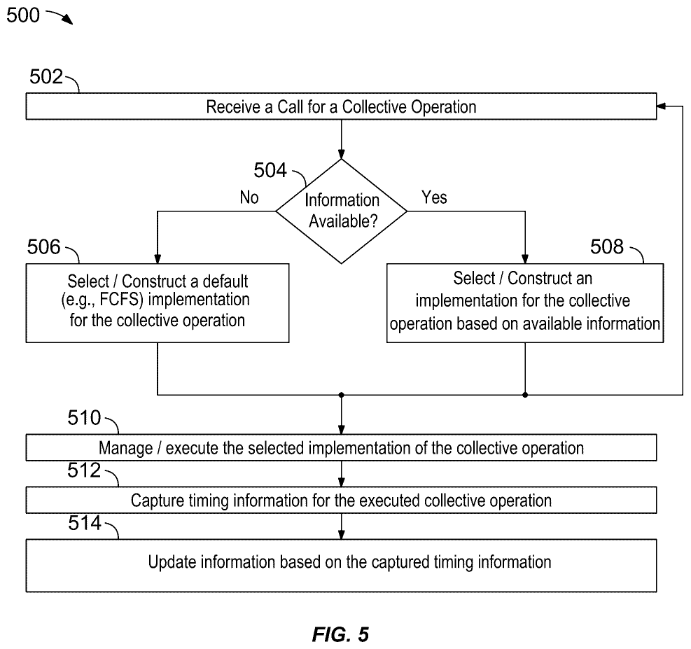

Collective manager 120 further includes a collective orchestrator 316 that orchestrates execution of collective implementation 314 based on collective operation parameters and sequence information of collective implementation 314. Collective orchestrator 316 essentially executes and/or manages data movement amongst compute nodes 102 for the requested collective operation based on collective implementation 314. Collective orchestrator 316 may include a timestamp engine 318 that gathers timestamps 126 from compute nodes 102. Collective orchestrator 316 may also issue collective returns 126 to compute nodes 102 to permit application program 140 to continue after issuing collective call 124. FIG. 3 is further described below with reference to FIG. 5.

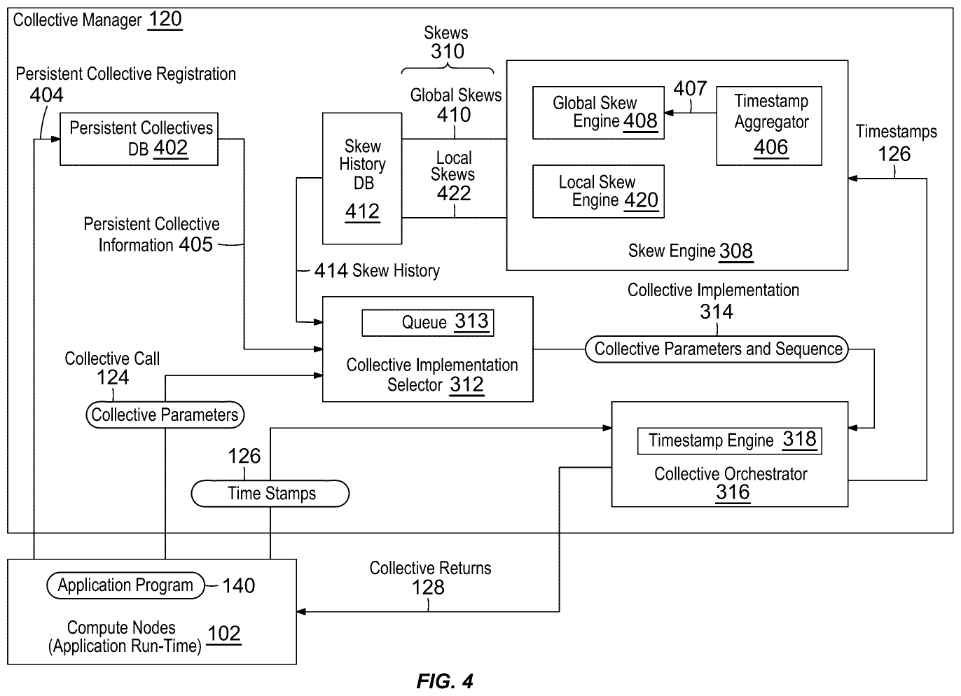

FIG. 4 depicts collective manager 120, according to an embodiment. In the example of FIG. 4, collective manager 120 further includes a persistent collectives database 402 that stores information related to persistent collective operations of application program 140. A persistent collective operation is a collective operation and/or a sequence of collective operations that execute repetitively with respect to one or more compute nodes 102. Persistent collectives database 402 may receive the information related to persistent collective operations in the form of persistent registrations 404. The information may identify the persistent collective operations or sequence of collective operations, corresponding implementations, compute nodes 102 impacted by the persistent collective operation, and/or other information related to the persistent collective operations. Persistent collectives database 402 may include a look-up table (LUT) indexed by collective operations (e.g., a first collective operation of a sequence of collective operations).

In FIG. 4, collective manager 120 further includes a local skew engine 420 that determines (e.g., computes and/or predicts) local skews 422 (e.g., skews across multiple subsets of compute cores 102) based on local timestamps 126. Collective manager 120 further includes a timestamp aggregator 406 that aggregates timestamps 126 to provide aggregated timestamps 407. Collective manager 120 further includes a global skew engine 408 that determines global skews 410 (i.e., skews across multiple subsets of compute cores 102) based on aggregated timestamps 407. Collective manager 120 further includes a skew history database 412 that includes a table(s) and/or other data structure(s) for maintaining skew histories 414 based on local skews 422 and/or global skews 410. Skew history database 412 and/or collective implementation selector 312 may associate skew histories 414 with collective calls in collective call queue 313 and/or other queue(s).

FIG. 4 is further described below with reference to FIG. 5.

FIG. 5 is flowchart of a method 500 of selecting implementations for collective operations of an application program, according to an embodiment. Method 500 is described below with reference to FIGS. 1 through 4. Method 500 is not, however, limited to the examples of FIGS. 1 through 4.

At 502, collective manager 120 receives collective call 124 from application program 140. Collective implementation selector 312 may place collective call 124 in a collective call queue 313. Collective calls in queue 313 may be referred to as abstract collective calls, in that the collective calls do not specify implementations for the collective operations.

At 504, if collective manager 120 lacks information regarding the specified collective operation (e.g., current/past skew information, persistent collective information, durations of available collective implementations), processing proceeds to 506, where collective implementation selector 312 selects or constructs a default implementation (e.g., first-come first-serve) for collective implementation 314. If collective manager 120 has information regarding the specified collective operation, processing proceeds to 508.

At 508, collective implementation selector 312 determines collective implementation 314 based on available information, which may include skews 310, local skews 422, global skews 410, skew histories 414, persistent collective information 405, and/or other available information. Collective implementation selector 312 may select and/or construct collective implementation 314 based further on local and/or global parameters of network 101 related to execution of application program 140 and/or based on parameters of collective call 124. Parameters may include, without limitation, a number of compute nodes 102 involved in the collective operation, the size of a message being communicated, physical topology of network 101, timestamps 126, and/or skews 310.

Collective implementation selector 312 may determine collective implementation 314 to absorb and/or reduce skew/misalignment amongst compute nodes 102. Collective implementation selector 312 may determine collective implementation 314 to reduce a duration of the collective operation on one or more of the compute nodes, to reduce stalls, and/or to reduce occupancy/usage of network interface resources. Collective implementation selector 312 may prioritize the duration of the collective operation, stall reduction, and usage of network interface resources, in that order.

Collective implementation selector 312 may determine collective implementation 314 based on available implementations of the collective operation specified in collective call 124 (e.g. flat tree, binomial tree, recursive doubling, and/or rings). A communication tree may specify compute nodes 102 to transmit and/or receive messages, and a sequence in which the messages are to be transmitted and/or received by the respective compute nodes.

Collective implementation selector 312 may select and/or construct collective implementation 314 based on one or more models, which may include an analytical model and/or a machine learning (ML) model, such as a neural network. The model(s) may model, for example and without limitation, durations of available collective implementations, current skew information, prior skew information, and/or information regarding persistent collective operations.

Collective implementation selector 312 may determine a sequence of collective implementations for a sequence of collective operations of queue 313, based on relationships amongst the collective operations (e.g., to minimize an overall runtime of the sequence of collective operations).

In an example, collective manager 120 determines collective implementation 314 based on current local timestamps 126 (e.g., current local skews 422), and assumptions regarding one or more other factors (e.g., homogeneous distribution of work across nodes). In this example, collective manager 120 may determine collective implementation 314 without use of global skews 410, skew history 414, and persistent collective information 405.

In another example, the collective operation specified in call 124 corresponds to a persistent collective operation registered in persistent collective database 402, and skew history database 412 includes skew information related to a compute operation executed by one or more compute nodes 102 subsequent to the persistent collective operation. In this example, collective implementation selector 312 may estimate a duration of the compute operation, and may determine collective implementation 314 based in part on the estimated duration. Collective implementation selector 312 may access the LUT of persistent collectives database 404, based on collective call 124, to determine whether collective call 124 relates to a persistent collective operation.

In another example, collective implementation selector 312 operates speculatively to anticipate a collective call for a persistent collective operation. In this example, collective implementation selector 312 may determine a collective implementation for the anticipated collective call based in part on persistent collective information 405, prior to receiving the anticipated collective call. Collective implementation selector 312 may cache the collective implementation for the anticipated collective call. Collective implementation selector 312 may determine the collective implementation for the anticipated collective call in parallel with determining the collective implementation 314 for a current collective call.

In another example, collective implementation selector 312 includes behavior models that model behaviors of one or more collective operations. In this example, collective implementation selector 312 may use the behavior models in conjunction with collective call queue 313 to pre-compute collective implementations for entries of collective call queue 313.

In another example, collective implementation selector 312 considers a sequence of entries of collective call queue 313, and determines collective implementations 314 for the respective entries to optimize the sequence of collective operations globally.

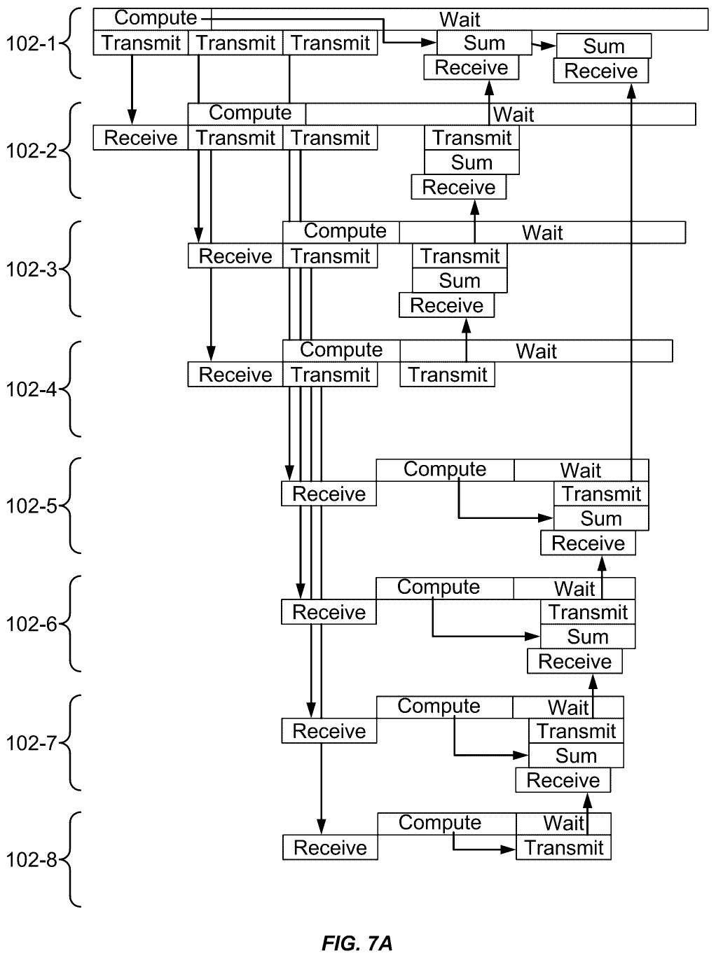

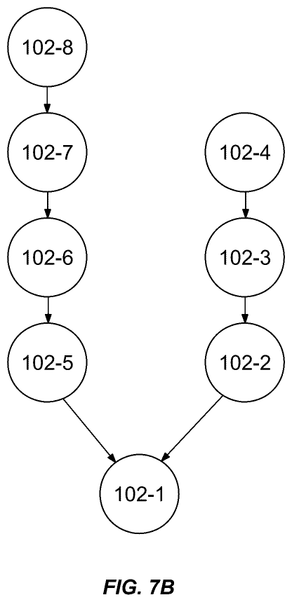

In some situations, collective implementation selector 312 may determine a collective implementation 314 that includes more communication operations than necessary, yet reduces the overall duration of a collective operation or sequence of collective operations, examples of which are provided further below with reference to FIGS. 7A through 15B.

At 510, collective orchestrator 316 executes and/or manages (e.g., distributes instructions to compute nodes 102) collective implementation 314, examples of which are provided further below with reference to FIGS. 7A through 15B.

In an example, collective implementation 314 is executed by an orchestrator thread executing on a system, which may include a host system, a compute node 102, or a network interface controller. The orchestrator thread may be offloaded from one system to another system one At 512, timestamp engine 318 captures timestamps 126 related to the execution of collective implementation 314 (i.e., current timestamps). Timestamp engine 318 may capture timestamps individually from one or more compute nodes 102. Such timestamps may be referred to as local timestamps. Alternatively, or additionally, timestamp engine 318 may capture timestamps from multiple and/or all compute nodes 102 via a single operation (e.g., via a gather operation). Such timestamps may be referred to as global timestamps.

At 514, collective manager 120 updates information based on the current timestamps. In FIG. 3, skew engine 308 determines skews 310 based on the current timestamps.

In FIG. 4, local skew engine 420 determines local skews 424 based on timestamps 126, timestamp aggregator 406 aggregates the current timestamps with prior timestamps, and global skew engine 408 determines (e.g., computes and/or estimates) global skews 410 based on aggregated timestamps 407 and/or based model-based estimated timestamps and/or estimated local skews. Global skew engine 408 may determine global skews 410 based on aggregated timestamps 407 and/or based model-based estimated timestamps and/or estimated local skews 422. Collective manager 120 may update skew history database 412 based on local skews 422 and/or global skews 410. If the collective operation specified in collective call 124 is a persistent collective operation, collective manager 120 may update persistent collectives database 402 with information related to execution of collective implementation 314. Collective manager (e.g., skew history database and/or collective implementation selector 312) may further detect trends in local skews 422 and/or global skews 410.

Collective manager 120 (e.g., collective implementation selector 312 and/or skew engine 308) may predict information for one or more compute nodes 102 based on timestamps 126 of one or more other compute nodes 102 and/or based on other information such as workloads (e.g., numbers of tokens sent to compute nodes 102 that include artificial intelligence engines). Other information, such as workloads, may be based on user-provided application-specific models. As examples, and without limitation, collective manager 120 may predict delays/skews, start times, stop times, and/or durations of collective operations and/or compute operations. Global skew engine 408 may determine (e.g., compute and/or predict) global skews 410 based in part on the predicted information.

Example implementations of collective manager 120, skew engine 308, collective implementation selector 312, and collective orchestrator 316 are provided below.

In an example, collective manager 120 represents an application program, which may include an application programming interface (API), executing on one or more processors of system 100 (e.g., a host system, a compute node 102, and/or a network interface controller). In this example, skew engine 308, collective implementation selector 312, and/or collective orchestrator 316 may represent respective execution threads of the application program, which may be offloaded from a host system or a compute node 102 to another device, such as a network interface controller or an accelerator circuit, such as a pipelined accelerator circuit of a smart network interface controller (SmartNIC).

In another example, skew engine 308, collective implementation selector 312, and/or collective orchestrator 316 represent respective application programs, which may execute on the same system (e.g., a host system, a compute node 102, and/or a network interface controller), or which may execute on separate systems. In this example, tasks/threads of one or more of the application programs may be offloaded to another system.

In another example, skew engine 308 includes and/or represents a local skew thread and/or application that determines local skews 422, a timestamp aggregator thread and/or application that aggregates timestamps 126, and a global skew thread and/or application that determines global skews 410. The local skew thread/application, the timestamp aggregator thread/application, and the global skew thread/application may execute on the same system or on separate systems. The local skew thread/application, the timestamp aggregator thread/application, the global skew thread/application, or portions thereof, may be offloaded from one system to another system.

In another example, collective orchestrator 316 includes and/or represents an orchestrator thread and/or application that executes collective implementation 314, and a timestamp thread and/or application that gathers timestamps 126. The orchestrator thread/application and the timestamp thread/application may execute on the same system or on separate systems. The orchestrator thread/application and/or the timestamp thread/application, or portions thereof, may be offloaded from one system to another system. The timestamp thread/application may gather timestamps 125 based on an all-gather collective.

In another example, collective implementation selector 312 includes and/or represents a collective communication library (CCL) that accepts custom collective implementation scenarios.

The forgoing examples are not mutually exclusive, and may be combined in various combinations with one another.

Hierarchical features/considerations are addressed below. Network 101 may include tens, hundreds, or thousands of compute nodes 102. Gathering timestamps, determining skews, and determining collective implementations for numerous compute nodes in a timely fashion may be challenging. In such an environment, automatic run-time skew-aware optimization of rooted collectives may be performed in a distributed manner. In an example, instances of collective manager 120 may be provided for respective stages (e.g., subsets of compute nodes 102) of a hierarchical decomposition of network 101.

In examples below, “wait” periods represent periods in which execution of application program 140 waits or stalls until a communication (e.g., a “transmit” or a “receive” communication) completes. “Interference” periods represent periods in which application program 140 is not forced to wait, but if execution of application program 140 continues, it may experience reduced performance due to simultaneous execution of a communication process.

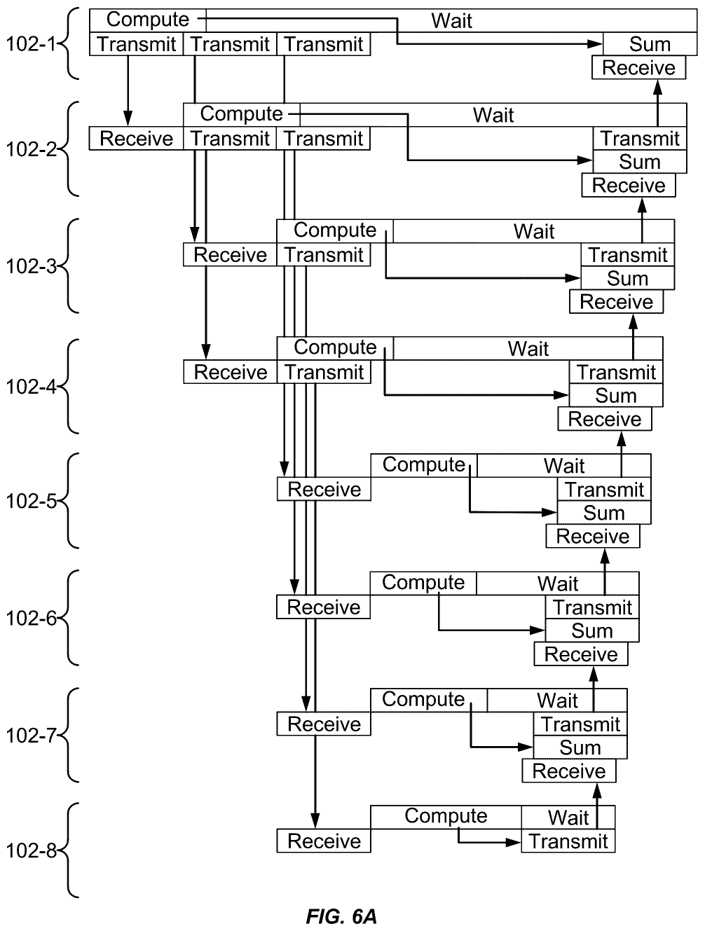

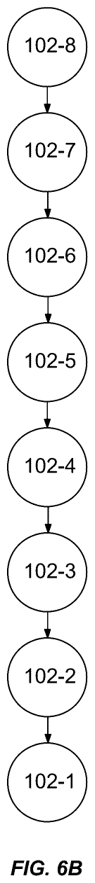

Example reduction operations are provided below with reference to FIGS. 6A, 6B, 7A, and 7B. FIG. 6A depicts a skew-unaware pipelined (i.e., segmented) linear reduction operation, according to an embodiment. In the example of FIG. 6A, the reduction operation is depicted as sum operations, executed on compute nodes 102-1 through 102-8, following a binomial tree broadcast, illustrated here as transmit operations. In the example of FIG. 6A, the transmit operations result in skew amongst the compute nodes (i.e., differing compute start times that result in differing available reduction start times). FIG. 6B depicts ordering of the reduction operation of FIG. 6A. Compute nodes that finish respective compute operations earlier, wait for the reduction to finish.

In FIG. 6A, following the binomial tree broadcast, the compute nodes are skewed in two groups (i.e., compute nodes 102-1 through 102-4, and compute nodes 102-5 through 102-8), depending on their distance to the root of the binomial tree. As depicted in FIG. 6B, the skew-agnostic implementation of FIG. 6A implements a daisy-chain through the compute nodes, such that compute nodes 102-1 through 102-4, must wait to receive data from compute node 102-5.

In the example of FIG. 6A, T=Tsmax+P*(A+S/B)+(M−S)/B, where
M represents a message size,
S represents a segment size,
P represents a communicator size,
A represents latency,
B represents bandwidth,
T represents a duration of the collective operation (e.g., a time from when a first one the compute nodes begin executing the collective operation, to a time when a last one of the compute nodes completes the collective operation),
Tsmax represents a maximum relative skew, and
Txmin represents a minimum relative skew.

FIG. 7A depicts a skew-aware reduction operation, according to an embodiment. FIG. 7B depicts ordering of the reduction operation of FIG. 7A. The example of FIG. 7A represents a skew-aware approach that determines a collective transmission tree at run-time based on skew information. In this example, collective manager 120 separates the pipeline into two segments (i.e., two half-length linear pipelines) corresponding to the skew groups, as depicted in FIG. 7B. The two half-length line pipeline have lower latency relative to FIG. 6B, and thus reduces wait times.

The skew-aware reduction operation of FIG. 7A results from fracturing the reduction into two stages applied to each skew group, and the daisy-chain is structured to reflect predicted skews to allow the natural flow of data from leading compute nodes to trailing compute nodes. A daisy-chain pipeline implementation may not be amenable to FCFS, but may be useful when if skew information (measured and/or predicted), such that that the daisy-chain is ordered ahead of time (i.e., pre-ordered). The visible latency of the reduction for FIG. 7A may be up to 2×lower than the non-hierarchical, skew-agnostic daisy-chain of FIG. 6A, depending on the size of skew groups, latencies, bandwidth, and message sizes.

In the example of FIG. 7A, T=Tsmax+(P/2+1)*(A+S/B)+(M−S)/B.

The example of FIG. 7A improves latency by up to 2×, depending on the number of skew groups and the size of the skew. A compute node that completes its compute operation earlier than other compute nodes will complete its reduction earlier and is thus available to attend to other compute tasks.

In FIG. 7A and FIG. 7B, if collective manager 120 determines (e.g., predicts) that there is a slight skew amongst the compute operations of compute nodes 102-5 through 105-8, collective manager may order compute nodes 102-5 through 105-8 based on the skew.

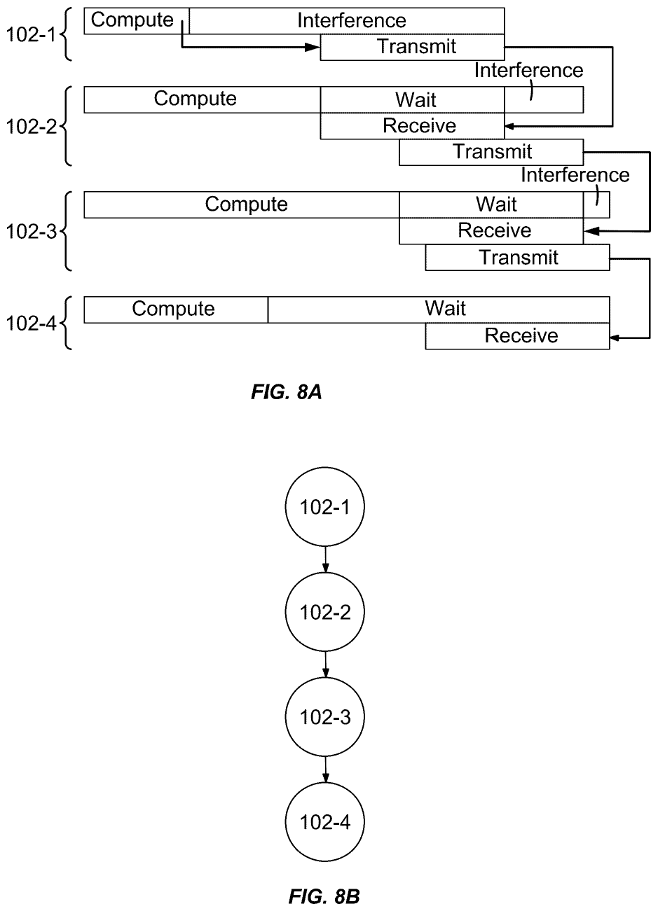

Example broadcast operations are provided below with reference to FIGS. 8A through 10B, in which skew-agnostic pipelined linear and FCFS tree are compared against a skew-guided pipelined linear implementation. Broadcast can be modeled as a reduction in reverse. As such, the above example and approximate speed-up calculations for skew-aware reduction apply to broadcast as well, for the same skew pattern and root.

FIG. 8A depicts a skew-unaware pipelined linear broadcast from compute node 92-1. FIG. 8B depicts ordering of the broadcast of FIG. 8A. In the example of FIG. 8A, transmit finishes faster on compute node 92-1. A global duration of the broadcast may be acceptable for some situations, but compute node 92-4 must wait because it is at the end of the pipeline, yet it finishes its compute operation ahead of the other compute nodes. For the example of FIG. 8, T=Tsmax+P*(A+S/B)+(M−S)/B

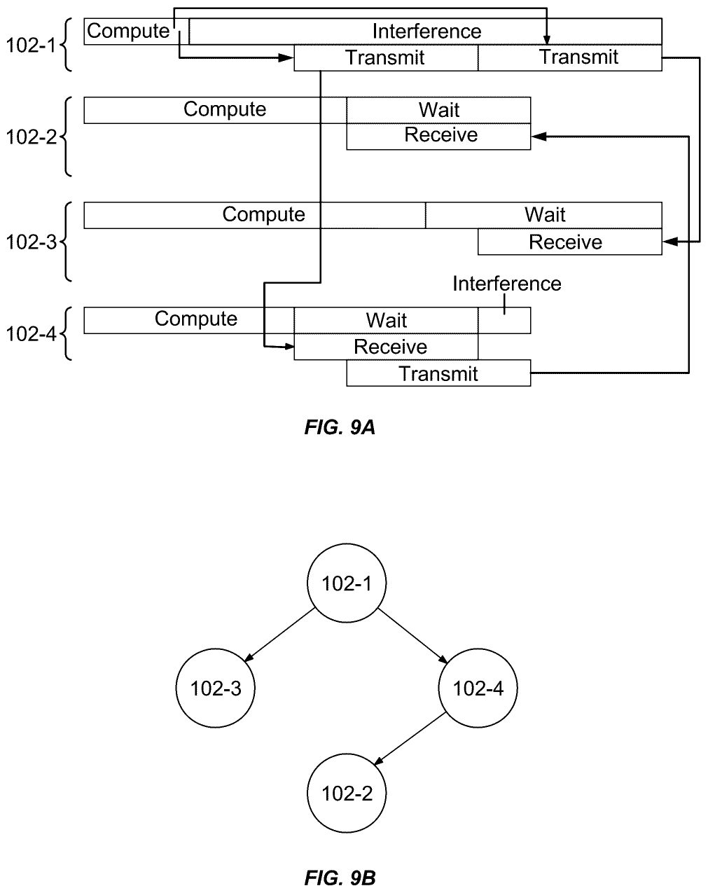

FIG. 9A depicts a skew-unaware first-come first-serve (FCFS) tree broadcast. FIG. 9B depicts ordering of the broadcast of FIG. 9A. The FCFS binary tree implementation of FIG. 9A does not provide any significant benefit relative to the example of FIG. 8A, but may be faster in other situations. In general, FCFS tree broadcast may not be more than 2×slower than a skew-agnostic pipelined linear broadcast. In FIG. 9A, compute node 102-1 must wait for a first available child compute node (e.g., compute node 102-4) before transmitting results of its compute operation. In addition, compute node 102-3 must wait while compute node 102-1 transmits to compute node 102-4, before compute node 102-1 can transmit to compute node 102-3. The example of FIG. 9 illustrates a sub-optimal broadcast duration, globally.

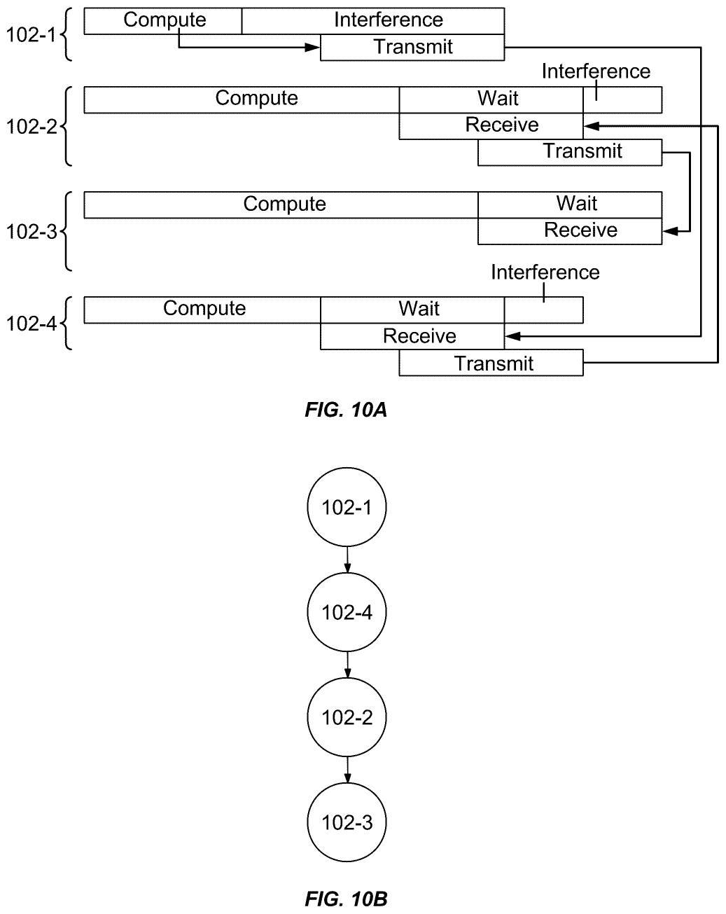

FIG. 10A depicts a skew-aware pipeline broadcast, according to an embodiment. FIG. 10B depicts ordering of the broadcast of FIG. 10A, according to an embodiment. As illustrated in FIG. 10A, skew-aware pipeline broadcast may provide an optimal duration (e.g., with respect to broadcast completion, wait times, and/or interference durations). Skews dictate the order of nodes in the pipeline such that the collective always has optimal duration on the final node of the pipeline, which is the most skewed. No excessive waiting on any specific node.

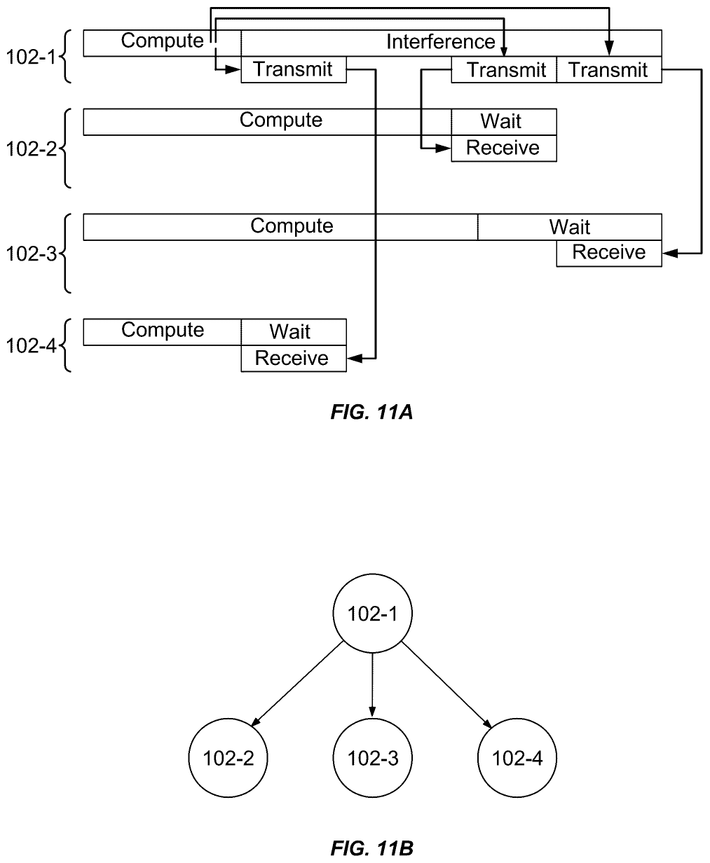

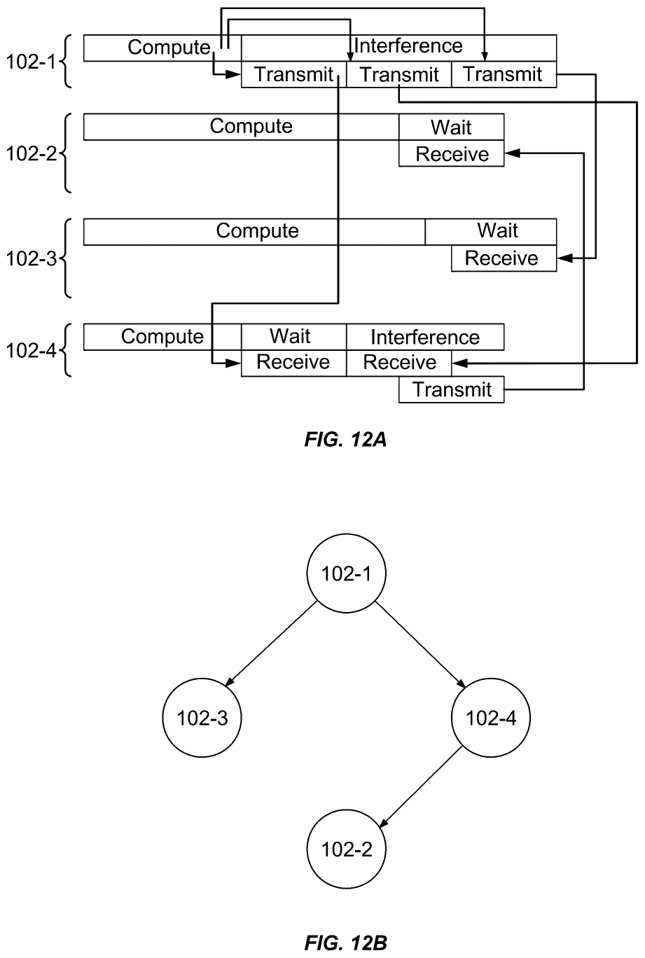

Example scatter operations are provided below with reference to FIGS. 11A, 11B, 12A, and 12B.

FIG. 11A depicts a skew-unaware FCFS scatter operation. FIG. 11B depicts ordering of the scatter operations of FIG. 11A. Scatter minimum duration is defined by the transmit throughput of the root and the size of the communicator. Skews may add to this minimum duration, as illustrated in FIG. 11A. Skew-awareness allows some data to take alternative routes to highly skewed nodes, via nodes that are less skewed. In the example of FIG. 11A, compute node 102-3 must wait for the root to finish sending to compute node 1. Total duration is sub-optimal.

FIG. 12A depicts a skew-aware scatter operation, according to an embodiment. FIG. 12B depicts ordering of the reduction operations of FIG. 12A, according to an embodiment. In the example of FIG. 12A, compute node 102-4 acts as a proxy for node 102-2 because compute node 102-4 is available to receive before compute node 102-2 is available to receive. Compute node 102-4 starts sending data to compute node 102-2 as soon as compute node 102-2 is available to receive. The scatter operation finishes on compute node 102-4 and application program 140 can continue before the proxy thread itself finishes forwarding the data from the root to node (i.e., compute node 102-1) to compute node 102-2.

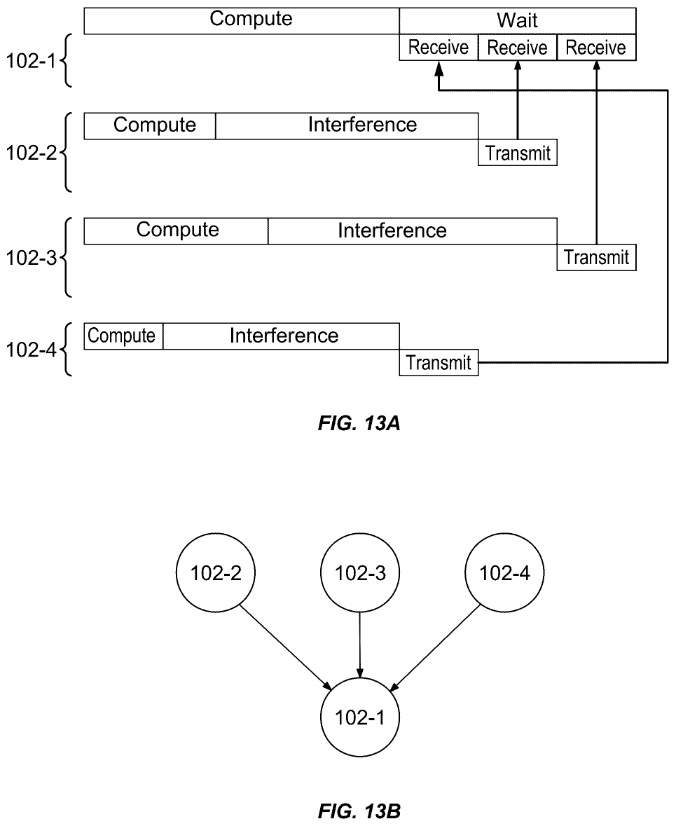

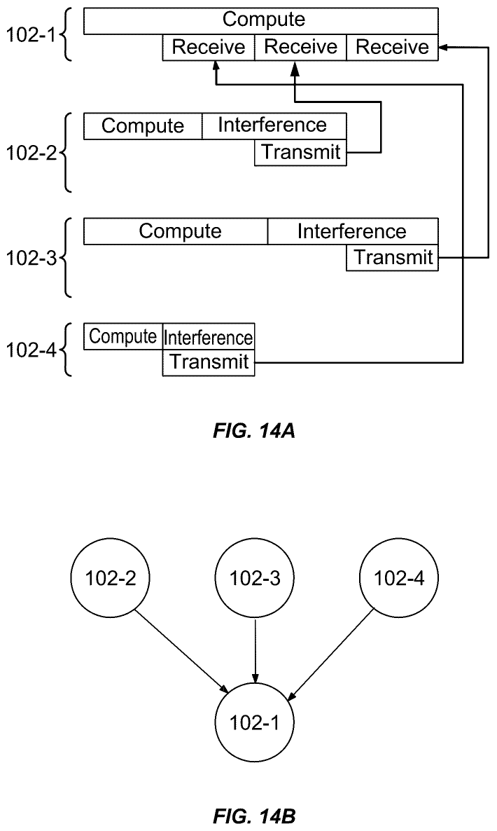

Example gather operations are provided below with reference to FIGS. 13A, 13B, 14A, and 14B. Gather may be viewed as the opposite of scatter, and approximate behaviors of scatter may apply to gather. In addition, FCFS may reduce skews from the perspective of the root (for root centered collectives). The foregoing factors are illustrated in the following gather examples.

FIG. 13A depicts a skew-unaware FCFS gather operation. FIG. 13B depicts ordering of the gather operations of FIG. 13A. In FIG. 13A, a duration of the gather operation is determined by the receive throughput of the root (i.e., compute node 102-1). From the viewpoint of compute node 102-1, the duration of the gather operation may appear optimal. However, compute nodes 102-2, 102-3, and 104-4 must wait for extended periods of time before compute node 102-1 is ready to receive.

FIG. 14A depicts a persistent skew-aware gather operation, according to an embodiment. FIG. 14B depicts ordering of the gather operations of FIG. 14A, according to an embodiment. Where collective manager 120 predicts that the root will arrive later to the synchronization point, collective manager 120 may prepare in advance to orchestrate receive operations from other compute nodes.

Additional examples of automatic run-time skew-aware optimization of rooted collectives are provided below. In an example, a system includes a processor and memory encoded with instructions which, when executed, cause the processor to determine skews amongst compute nodes of a distributed computing system, as an application program executes on the compute nodes, receive calls for collective operations from the application program, and determine implementations for the collective operations based at least in part on the skews.

In another example, a system includes a distributed computing system having a plurality of compute nodes, and a collective operation manager that determines skews amongst the compute nodes, as an application program executes on the compute nodes, receives calls for collective operations from the application program, and determines implementations for the collective operations based at least in part on the skews.

In another example, a method includes determining skews amongst compute nodes of a distributed computing system, as an application program executes on the compute nodes, via a first thread executing on one or more of a host computer system, one of the compute nodes, and a network interface controller. The method further includes queuing calls for collective operation of the application program via a second thread executing on one or more of the host computer system, one of the compute nodes, and the network interface controller. The method further includes determining implementations for the collective operations based at least in part on the skews via a third thread executing on one or more of the host computer system, one of the compute nodes, and the network interface controller.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system, comprising:
a processor and memory encoded with instructions which, when executed, cause the processor to,
determine skews amongst compute nodes of a distributed computing system, as an application program executes on the compute nodes,
receive calls for collective operations from the application program, and
determine implementations for the collective operations based at least in part on the skews.

2. The system of claim 1, wherein the instructions, when executed, further cause the processor to:
queue the calls for the collective operations in a collective call queue; and
determine the implementations for multiple collective operations of the collective call queue, prior to executing the implementations for the multiple collective operations, based on skew impacts amongst the multiple collective operations.

3. The system of claim 1, wherein the instructions, when executed, further cause the processor to:
determine the implementations for the collective operations based further on prioritized criteria that comprise reduction of a duration of the collective operation on one or more of the compute nodes, reduction of stalls, and reduction of usage of network interface resources.

4. The system of claim 1, wherein the instructions, when executed, further cause the processor to:
determine the implementations for the collective operations based on one or more of,
current skews of the application program, and
a history of skews of the application program.

5. The system of claim 1, wherein the instructions, when executed, further cause the processor to:
determine the implementations for the collective operations based further on information related to persistent collective operations of the application program.

6. The system of claim 1, wherein the instructions, when executed, further cause the processor to:
predict a subsequent collective operation of the application program based on a collective operation specified in a current call for a collective operation and information related to persistent collective operations of the application program; and
determine an implementation for the predicted subsequent collective operation based on the skews and the information related to the persistent collective operations of the application program, prior to receiving a call for the subsequent collective operation.

7. The system of claim 6, wherein the instructions, when executed, further cause the processor to:
determine the implementation for the collective operation specified in the current call and the implementation for the predicted subsequent collective operation in parallel.

8. The system of claim 1, wherein the instructions, when executed, further cause the processor to:
determine the skews based on times stamps related to one or more of,
collective operation start times,
collective operation completion times, and
compute operation start times, and
compute operation completion times.

9. The system of claim 8, wherein the instructions, when executed, further cause the processor to:
estimate timestamps for one or more of the compute nodes based on the timestamps of one or more other ones of the compute nodes.

10. The system of claim 9, wherein the instructions, when executed, further cause the processor to:
aggregate the timestamps from multiple ones of the compute nodes;
determine the skews as global skews based on the aggregated timestamps; and
determine the implementations for the collective operations based at least in part on the global skews.

11. The system of claim 10, wherein the instructions, when executed, further cause the processor to:
estimate timestamps for one or more of the compute nodes based on the timestamps of one or more other ones of the compute nodes; and
determine the global skews based further on the estimated timestamps.

12. The system of claim 1, wherein the instructions, when executed, further cause the processor to:
determine the implementations for the collective operations based further on available start times of the compute nodes.

13. The system of claim 10, wherein the instructions, when executed, further cause the processor to:
detect a trend in the global skews; and
determine the implementation for the collective operation based further on the trend.

14. A system, comprising:
a distributed computing system comprising a plurality of compute nodes; and
a collective operation manager configured to,
determine skews amongst the compute nodes, as an application program executes on the compute nodes,
receive calls for collective operations from the application program, and
determine implementations for the collective operations based at least in part on the skews.

15. The system of claim 14, wherein the collective operation manager is further configured to:
queue the calls for the collective operations in a collective call queue; and
determine the implementations for multiple collective operations of the collective call queue, prior to executing the implementations for the multiple collective operations, based on skew impacts amongst the multiple collective operations.

16. The system of claim 14, wherein the collective operation manager is further configured to:
determine the implementations for the collective operations based further on prioritized criteria that comprise reduction of a duration of the collective operation on one or more of the compute nodes, reduction of stalls, and reduction of usage of network interface resources.

17. The system of claim 14, wherein the collective operation manager comprises one or more of:
an integrated circuit comprising logic configured to perform one or more functions of the collective operation manager; and
a non-transitory computer readable medium encoded with instructions to cause a processor to perform one or more functions of the collective operation manager.

18. The system of claim 14, wherein the collective operation manager is further configured to:
determine the skews based on times stamps related to one or more of,
collective operation start times,
collective operation completion times,
compute operation start times, and
compute operation completion times.

19. A method, comprising:
determining skews amongst compute nodes of a distributed computing system, as an application program executes on the compute nodes, via a first thread executing on one or more of a host computer system, one of the compute nodes, and a network interface controller;
queuing calls for collective operation of the application program via a second thread executing on one or more of the host computer system, one of the compute nodes, and the network interface controller; and
determining implementations for the collective operations based at least in part on the skews via a third thread executing on one or more of the host computer system, one of the compute nodes, and the network interface controller.

20. The method of claim 19, further comprising:
executing the implementations of the collective operations via a fourth thread executing on one or more of the host computer system, one of the compute nodes, and the network interface controller.
